(19) United States
(12) Patent Application Publication
(10) Pub. No.: US 2015/0072645 A1
(43) Pub. Date: Mar. 12, 2015

(54) METHOD FOR MANAGING PREPAID WIRELESS ACCOUNTS

(71) Applicant: Carl Jibril Sulaiman, II, Pensacola, FL (US)

(72) Inventor: Carl Jibril Sulaiman, II, Pensacola, FL (US)

(21) Appl. No.: 14/482,050

(22) Filed: Sep. 10, 2014

Related U.S. Application Data
(60) Provisional application No. 61/876,335, filed on Sep. 11, 2013.
(60) Provisional application No. 61/876,345, filed on Sep. 11, 2013.

(51) Int. Cl. H04M 17/00; H04W 4/24

(52) U.S. Cl. CPC H04M 17/205; H04W 4/24; H04M 17/207; H04M 17/208
USPC 455/407

(57) ABSTRACT

Methods and software application for automatic loading of a refill pin in a prepaid wireless customer's account generally comprising engaging an external server to send request with phone number, PIN and wireless carrier information; navigating and logging on to wireless carrier's website; determining a first automated PIN number loading script based on the customer's wireless carrier; running first automated PIN number loading script to obtain PIN response from wireless carrier's website; extracting validation response for PIN number loading from wireless carrier's website; and returning a PIN number loading validation response to said external server. An alternative method comprises generally engaging an external server to send request with phone number, PIN and wireless carrier information; accessing the interactive voice response (“IVR”) of wireless carrier system to input phone number and PIN number; using voice recognition to extract a PIN number loading validation response from said IVR; and returning said response to said external server.

### RELATED APPLICATIONS

This application claims priority to U.S. Provisional Application No. 61/876,335 filed Sep. 11, 2013 and 61/876,345 filed Sep. 11, 2013. The entire contents of the above application are hereby incorporated by reference as though fully set forth herein.

### FIELD

The present invention relates to the field of pre-paid wireless. More specifically, the present invention relates to methods, systems and software applications for managing pre-pair wireless accounts.

### BACKGROUND

While traditionally prepaid wireless airtime has been primarily sold by retail wireless stores where number verification and pin loading has been typically performed by a sales rep or the subscriber at the time of purchase, increasingly prepaid wireless airtime is now sold through 3rd party websites, mobile apps or automated IVR platforms. Typically when airtime is sold by these 3rd party electronic means there is no way to refill the prepaid the wireless account without manual input if it is controlled by a second tier or lower wireless carrier, also known as an MVNO.

Mobile Virtual Network Operators (“MVNO”) seek to make money in the prepaid wireless market by leasing wireless telephone and data spectrum from the major wireless carriers and then sell the signal to the public through talk, data and web prepaid plans. With the market for prepaid wireless providers saturated, significant, game-changing innovations are needed to enable new MVNOs and POS providers to scale into a successful long-term player in the prepaid wireless market, such as Tracfone, Boost and Virgin Mobile. In order for MVNOs to remain competitive, they must improve revenue margins by increasing efficiency and expanding service coverage. As such, it is important for retailers that sell the services of the MVNO to increase efficiency and to reduce the number of rejected prepaid refills by refilling MVNO wireless numbers quickly and easily.

Wireless retailers profit from prepaid wireless subscribers when they visit the store to reload their prepaid service. However, many customers prefer a more convenient method of payment, which can cut out the wireless retailer altogether from the process, resulting in lost revenues. While many wireless retailers have created their own e-commerce refill sites or manually input credit card information from over-the phone payments, there exists a need for a platform that can automatically process customer payments for wireless retailers that also allows instantaneous issuance of a prepaid pin and automatic loading of the refill pin into the customer's account. Currently, the refill pins are manually loaded into a customer's account, which results in data entry errors and long processing times. Increased efficiency in accepting payments and refilling the customer's account with prepaid funds results in higher customer retention and profit margins for wireless retailers.

As such, there exists a need for a platform for wireless retailer customers to make payments for prepaid services, as well as automatically refill pins and load them into the customer account.

### BRIEF SUMMARY OF THE INVENTION

The present invention seeks to meet these needs by providing a method for managing prepaid wireless accounts. In one embodiment of the present invention, a method for prepaid wireless payment processing is disclosed wherein a prepaid pin is instantly issued and loaded onto the wireless customer's account.

In one embodiment of the present invention, a method for automatic loading of a refill pin in a prepaid wireless customer's account is disclosed comprising (1) engaging an external server to send API request to validation server with phone number, pin number and customer's carrier information; (2) determining automated pin number loading script method based on a customer's carrier; (3) initializing a first automated pin number loading script based on said customer's carrier; (4) a means to navigate and log on to said customer's carrier website; (5) running said first automated pin number loading script; (6) extracting validation response from said website; and (7) returning said response to said external server.

The method further comprises a second automated pin number loading script based on said customer's carrier that is run through said website to load refill pin in the event said first automated pin number loading script returns an error.

In a second embodiment of the present invention, a method for automatic loading of a refill pin in a prepaid wireless customer's account is disclosed comprising (1) accessing interactive voice response (“IVR”) phone system of customer's carrier; (2) converting phone number and pin number into dual tone multiple frequency tones; (3) initializing a pre-timed script to load phone number and pin number into said customer's carrier's IVR requests input; (4) using voice recognition to extract validation response from said IVR; and (5) returning said response to said external server.

In another embodiment of the present invention, a software application for automatic loading of a refill PIN in a prepaid wireless customer's account from a wireless carrier is disclosed comprising a plurality of automated PIN number loading scripts to extract a PIN loading validation response. The software application further comprises a means to select a first automated PIN number loading script based on the customer's wireless carrier as well as a means to create a web session to run said first automated PIN number loading script through wireless carrier's website to extract the PIN loading validation response. The software application further comprises a means to select a second automated PIN number loading script based on the customer's wireless carrier to extract the PIN loading validation response as well as a means to create a web session to run said second automated PIN number loading script through wireless carrier's website to extract the PIN loading validation response. The software application further comprises a means to access the interactive voice response (“IVR”) of customer's wireless carrier system to input phone number and PIN number and means to use voice recognition to extract a PIN number loading validation response from said IVR. The software application further comprises a means for converting phone number and PIN number into dual tone multiple frequency (“DTMF”) tones as well as a plurality of pre-timed scripts to load phone number and PIN number into customer's wireless carrier's IVR requests input by playing DTMF tones.

### BRIEF DESCRIPTION OF THE DRAWINGS

FIG. 1. FIG. 1 is a schematic diagram illustrating the number validator flow according to the present invention.

### DETAILED DESCRIPTION

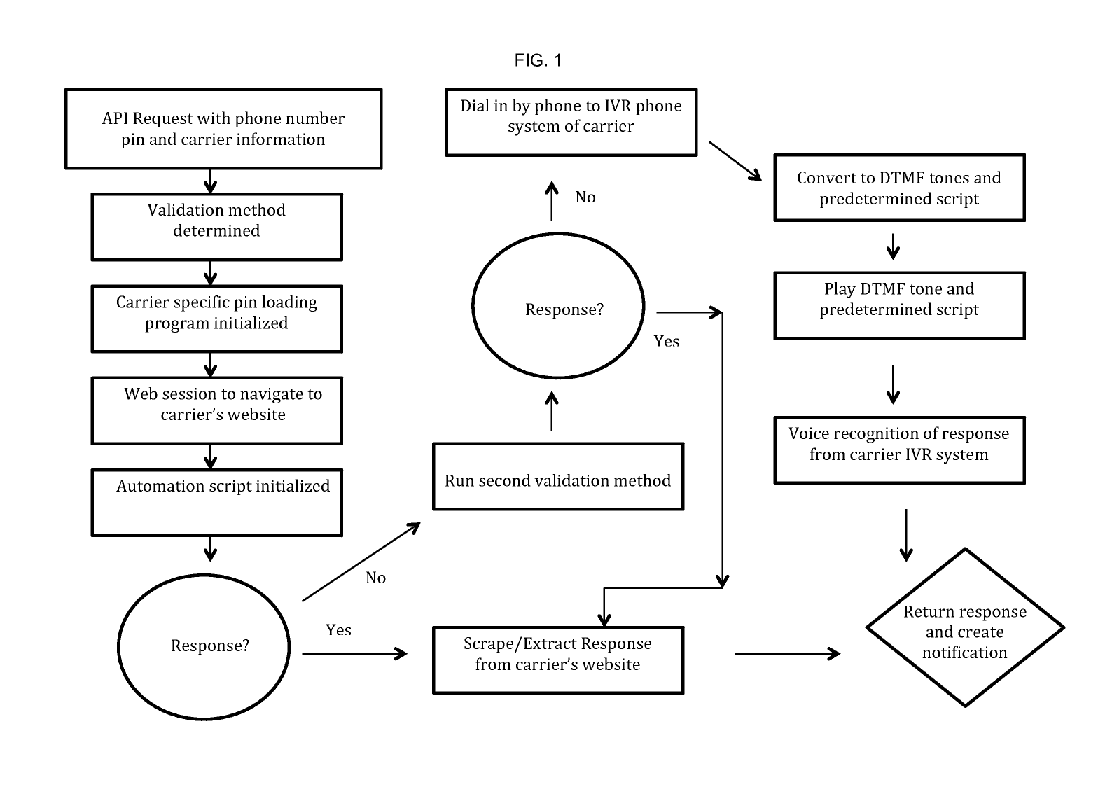

Turning to FIG. 1, the preferred methods of the pin number loading are disclosed. First, an external server (the end customer) sends an API request to a validation server that includes the phone number, the pin number and customer's carrier information, such as “555-555-5555”, PIN=1234 and AT&T. Next, a validation server (the validation service provider) uses the customer's carrier information to determine which pin loading script method is appropriate. Two examples of a simple pin loading scripts used with the present invention are set forth below; however, each customer's carrier requires a unique pin loading script. Next, the pin loading script for the customer's carrier is initialized. The automated pin loading script opens a web session and navigates to the website of the customer's carrier. Then the pin loading script is used to log on to the website of the customer's carrier and attempts to load the pin through the account refill form with that customer's carrier using the pin loading script sequence. In The validation server scrapes and/or extracts the response from the customer's carrier's website and the validation server translates the response as “Successful”, “Unsuccessful” or “Error.” The validation server returns the response to the external server that initially made the API request (end customer).

In the event the pin loading script returns an error, the validation server dials out through a telephone application and into the interactive voice response (“IVR”) phone system of the customer's carrier. The validation server converts the phone number and pin number into dual tone multiple frequencies (“DTMF”) tones and uses a pre-timed script to load the phone number and pin number with the carrier's IVR requests input. The validation server plays the pre-timed recordings and DTMF numbers of the phone number and pin number to the carrier's IVR. Then the validation server uses voice recognition to listen for the customer's voice response from the carrier's IVR. Finally, the validation server translates the response from Step 6 as “Successful”, “Unsuccessful” or “Error.” The validation server returns the response to the external server that initially made the API request (end customer).

### EXAMPLES OF PIN LOADING SCRIPT SEQUENCE

### Example 1

Carrier=Simple Mobile
   (1) Go to website—https://www.fastactportal.com/
   (2) Enter login credentials—thewirelessshoponline@gmail.com PASSWORD: 60016001
   (3) Go to website—https://www.fastactportal.com/processRedemption
   (4) Enter wireless number and pin number.
   (5) Press “reup” link
   (6) Scrape results (Successful Transaction) “Your redemption was successful”
   (7) If results fail 3 times, retry secondary method

### Example 2

Carrier=Simple Mobile
   (1) Go to website https ://www.simplemobile.com/wps/portal/home/h/refill/refill_pages/refillOnDemand/
   (2) Enter wireless number and pin number.
   (3) Press “Continue” link
   (4) Scrape results (Successful Transaction)
      “{reactivationSummaryPage:'/wps/portal/home/h/refill/refill_pages/reactivationS ummary/!ut/p/b1/lZHdboJAFISfxQeoexZ2YblEKALlR0CtcGPodkUoSEKpVp6-tOlFa2pMz91JvpnMZFCG0jtMsESoRiSCNig75MeyyPuyPeT1558pWxNcX450W5IjQwHHhRW9jymGkI5A-hOYkYCCI9OFxdwQzxXyT32sYAbOwptbJvZkYOotvYuy8qmZnngzhSnVVA 0w0xhTqCaN4keU_Ta4zKfcAsgl8EfCC8BWR4eFbSRzNYDQkr4BuHI6oMBu GzGGTTP1alcytunEa_vWcYHiTuzKut4e87p8_toKRTzne- GJo6gXeSFQgjZAtknFOv_hXPQGr3wgDAIzPA WmA32lD30Vnf2lnezhoBRlh AdD9oPZ2l_ydzyssD_s1oPH27XO011s8glqstpiL6VTqYMe6ZPJB7iwNW8!/dl4/d5/L3dIQSEvUUdRbkFBISEvNEprRS9aNl9EMEpNM1FBSDJCQkc1MElCNE FRVjlCMzA0Mg!!/'}”
   (5) If results fail 3 times, retry IVR load method.

For the purposes of promoting an understanding of the principles of the invention, reference has been made to the preferred embodiments illustrated in the drawings, and customer's language has been used to describe these embodiments. However, this customer's language intends no limitation of the scope of the invention, and the invention should be construed to encompass all embodiments that would normally occur to one of ordinary skill in the art. The particular implementations shown and described herein are illustrative examples of the invention and are not intended to otherwise limit the scope of the invention in any way. For the sake of brevity, conventional aspects of the method (and components of the individual operating components of the method) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections might be present in a practical device. Moreover, no item or component is essential to the practice of the invention unless the element is specifically described as “essential” or “critical”. Numerous modifications and adaptations will be readily apparent to those skilled in this art without departing from the spirit and scope of the present invention.

What is claimed is:

1. A method for a method for automatic loading of a refill PIN in a prepaid wireless customer's account from a wireless carrier comprising:
(i) engaging an external server to send request with phone number, PIN and wireless carrier information;
(ii) navigating and logging on to wireless carrier's website;
(iii) determining a first automated PIN number loading script based on the customer's wireless carrier;
(iv) running first automated PIN number loading script to obtain PIN response from wireless carrier's website;
(v) extracting validation response for PIN number loading from wireless carrier's website; and
(vi) returning a PIN number loading validation response to said external server.

2. The method of claim 1 further comprising creating a web session with wireless carrier's website.

3. The method of claim 1 wherein the validation response for PIN number is valid or invalid.

4. The method of claim 1 further comprising determining a first automated PIN number loading script based on the customer's wireless carrier.

5. The method of claim 5 further comprising running first automated PIN number loading script to obtain validation response for PIN number from wireless carrier's website.

6. The method of claim 5 further comprising determining a second automated PIN number loading script based on the customer's wireless carrier.

7. The method of claim 6 further comprising running second automated PIN number loading script to obtain validation response for PIN number from wireless carrier's website.

8. The method of claim 7 wherein the second automated PIN number loading script is only run in the event the first automated PIN loading script does not extract a validation response for PIN number.

9. A method for a method for automatic loading of a refill PIN in a prepaid wireless customer's account from a wireless carrier comprising:
(i) engaging an external server to send request with phone number, PIN and wireless carrier information;
(ii) accessing the interactive voice response (“IVR”) of wireless carrier system to input phone number and PIN number;
(iii) using voice recognition to extract a PIN number loading validation response from said IVR; and
(iv) returning said response to said external server.

10. The method of claim 9 further comprising converting phone number and PIN number into dual tone multiple frequency (“DTMF”) tones.

11. The method of claim 10 further comprising initializing at least one pre-timed script to load phone number and PIN number into customer's wireless carrier's IVR requests input by playing DTMF tones.

12. A software application for automatic loading of a refill PIN in a prepaid wireless customer's account from a wireless carrier comprising a plurality of automated PIN number loading scripts to extract a PIN loading validation response.

13. The software application of claim 12 further comprising a means to select a first automated PIN number loading script based on the customer's wireless carrier.

14. The software application of claim 13 further comprising a means to create a web session to run said first automated PIN number loading script through wireless carrier's website to extract the PIN loading validation response.

15. The software application of claim 12 further comprising a means to select a second automated PIN number loading script based on the customer's wireless carrier to extract the PIN loading validation response.

16. The software application of claim 15 further comprising a means to create a web session to run said second automated PIN number loading script through wireless carrier's website to extract the PIN loading validation response.

17. The software application of claim 16 wherein the second automated PIN loading script is selected in the event the first automated PIN loading script does not extract a PIN loading validation response.

18. The software application of claim 9 further comprising:
(i) means to access the interactive voice response (“IVR”) of customer's wireless carrier system to input phone number and PIN number;
(ii) means to use voice recognition to extract a PIN number loading validation response from said IVR.

19. The software application of claim 18 further comprising a means for converting phone number and PIN number into dual tone multiple frequency (“DTMF”) tones.

20. The software application of claim 19 further comprising a plurality of pre-timed scripts to load phone number and PIN number into customer's wireless carrier's IVR requests input by playing DTMF tones.
